(19) United States
(12) Patent Application Publication
(10) Pub. No.: US 2019/0317490 A1
(43) Pub. Date: Oct. 17, 2019

(54) CONTROL METHOD, DEVICE, AND REMOTE CONTROL FOR VR APPARATUS

(71) Applicant: AUTEL ROBOTICS CO., LTD., Shenzhen (CN)

(72) Inventor: Yinhua FENG, Shenzhen (CN)

(21) Appl. No.: 16/451,719

(22) Filed: Jun. 25, 2019

Related U.S. Application Data
(63) Continuation of application No. PCT/CN2017/114655, filed on Dec. 5, 2017.

(30) Foreign Application Priority Data
Dec. 26, 2016 (CN) 201611217535.X

(51) Int. Cl. G05D 1/00; B64C 39/02

(52) U.S. Cl. CPC G05D 1/0038; G05D 1/0016; B64C 2201/146; G05D 1/0022; B64C 39/024

(57) ABSTRACT

This disclosure relates to a communication control technology field and provides a control method, a device, and a remote control for a VR apparatus. The remote control may establish a communication connection to the VR apparatus, and may determine a virtual control in a mapping association with the function button after receiving a first operation on a function button configured for the remote control by a user, the virtual control being located on a display interface of the VR apparatus. The determined virtual control may be operated according to the first operation. Through the foregoing method, the user may control display of the VR apparatus by operating the remote control, thereby simplifying user operations and improving user experience.

### CROSS-REFERENCE TO RELATED APPLICATIONS

This application is a continuation of International Application No. PCT/CN2017/114655, filed on Dec. 5, 2017, which claims the priority to Chinese Patent Application No. 201611217535X, entitled “CONTROL METHOD, DEVICE, AND REMOTE CONTROL FOR VR APPARATUS” and filed with China Intellectual Property Administration, PRC on Dec. 26, 2016, both of which are incorporated by reference herein in their entireties.

### BACKGROUND

### Technical Field

This application relates to a communication control technology field, and in particular, to a control method, a device, and a remote control for a VR apparatus.

### Related Art

With the popularity of a Virtual Reality (VR) apparatus and Unmanned Aerial Vehicle (UAV) technologies, a manner may be implemented, in which a wide range of image information in a high-altitude scene may be captured by using a panoramic camera module carried by an aerial vehicle, and a wireless transmission technology such as WiFi, Bluetooth, Zigbee, or mobile communication, etc. is used to transmit the foregoing image information to a VR apparatus. The Unmanned Aerial Vehicle may be referred to as an aerial vehicle herein. In addition, a user may use a remote control to remotely control a flight of the aerial vehicle and adjust a camera device located on an aerial vehicle platform. The user may also control a display mode of an image displayed on the VR apparatus by controlling the VR apparatus, and the like.

However, in actual operation, due to a large number of apparatuses that need to be operated by the user, complexity of user operation is increased, resulting in poor user experience.

### SUMMARY

A control method, a device, and a remote control for a VR apparatus is provided in an embodiment of this application, so that a user can control a display function of the VR apparatus through a physical control of the remote control, thereby simplifying user operations and improving user experience.

In a first aspect, a control method for a VR apparatus is provided in an embodiment of this application. The method includes:

establishing a communication connection between a remote control and the VR apparatus;

after receiving a first operation on a function button of the remote control by the user, determining a virtual control in a mapping association with the function button, the virtual control being located on a display interface of the VR apparatus; and

controlling the virtual control according to the first operation.

In a second aspect, a control device for a VR apparatus is provided in an embodiment of this application. The control device includes:

a communication establishment module, configured to establish a communication connection between a remote control and the VR apparatus;

a mapping determining module, configured to determine a virtual control in a mapping association with a function button after receiving a first operation on a function button of the remote control by a user, the virtual control being located on a display interface of the VR apparatus; and

a widget control module, configured to control the virtual control according to the first operation.

In a third aspect, a remote control is further provided in an embodiment of the present invention, including:

at least one processor; and

a memory coupled to the at least one processor, where

the memory stores a computer instruction, and the processor is configured to invoke the computer instruction to perform the method in the first aspect.

In a fourth aspect, a non-volatile computer readable storage medium is further provided in an embodiment of the present invention. The computer readable storage medium stores a computer instruction, and the computer instruction is executed by a processor to perform the method in the first aspect.

In a fifth aspect, a computer program product is further provided in an embodiment of the present invention. The computer program product includes a computer program stored in a non-volatile computer readable storage medium, and the computer program includes a computer instruction. When the computer instruction is executed by a processor, the computer performs the above-mentioned method.

According to the control method, the device, and the remote control for the VR apparatus provided in the embodiments of the present invention, in the embodiments of this application, the remote control may establish a communication connection to the VR apparatus, and may determine the virtual control in the mapping association with the function button after receiving the first operation on the function button configured for the remote control by the user. The virtual control is located on the display interface of the VR apparatus. According to the first operation, the determined virtual control may be operated. Through the foregoing method, the user may control display of the VR apparatus by operating the remote control, thereby simplifying user operations and improving user experience.

### BRIEF DESCRIPTION OF THE DRAWINGS

FIG. 1 is a schematic architectural diagram of a communication system provided in an embodiment of this application;

FIG. 2 is a schematic flowchart of a control method for a VR apparatus according to an embodiment of this application;

FIG. 3 is a schematic flowchart of a control method for another VR apparatus according to an embodiment of this application;

FIG. 4 is a functional block diagram of a control device for a VR apparatus according to an embodiment of this application; and

FIG. 5 is a schematic structural diagram of hardware of a remote control performing a control method for a VR apparatus according to an embodiment of this application.

### DETAILED DESCRIPTION

Embodiments of this application are described below with reference to the accompanying drawings.

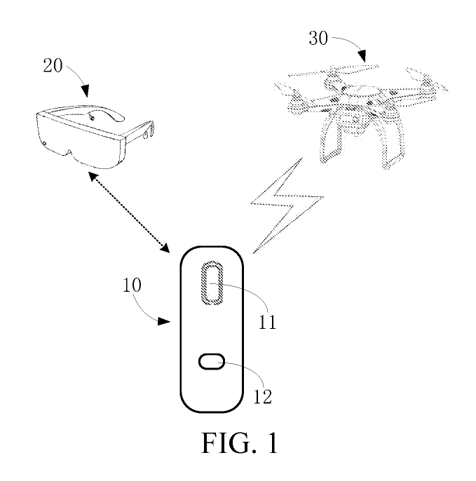

Referring to FIG. 1, FIG. 1 is a schematic architectural diagram of a communication system provided in an embodiment of this application. In the communication system, a remote control 10, a VR apparatus 20, and an aerial vehicle 30 may be included.

The method in the embodiment of the present invention is implemented by controlling the VR apparatus 20 and the aerial vehicle 30 based on the remote control 10 shown in FIG. 1.

In the communication system, a mutual communication connection between two devices may be implemented, that is, the remote control 10 may establish a communication connection to the VR apparatus 20, or may establish a communication connection to the aerial vehicle 30. In addition, the VR apparatus 20 may directly establish a communication connection to the aerial vehicle 30, or the VR apparatus 20 may establish a communication connection to the aerial vehicle 30 via the remote control 10, which is not limited herein.

The remote control 10 may be equipped with at least one function button. For example, the remote control 10 may be configured with at least one wheel button 11, each wheel button including at least three function buttons. The at least three function buttons may include a clockwise rotation button, an anti-clockwise rotation button, and a button, etc. The remote control 10 may receive a rotation operation on the wheel button 11 by a user, or receive a button operation on the wheel button 11 by the user. That is to say, the user may rotate the wheel button 11, or may press the wheel button 11. In addition, the remote control 10 may be configured with a switching button 12. As shown in FIG. 1, the switching button 12 may be configured to switch a current working mode of the remote control. Positions of the wheel button 11 and the switching button 12 shown in FIG. 1 are only illustrative and are not limited herein.

The VR apparatus 20 may include a display device. In particular, a display device such as a display screen or the like may be integrated in the VR apparatus 20. Alternatively, the VR apparatus 20 may also be detachably connected to an independent display device. For example, the independent display device is a display terminal that can be plugged into the VR apparatus 20, such as any one or more of a mobile phone, a tablet computer, and other mobile display terminals. A communication connection between the display device and the VR apparatus 20 is implemented by installing the display device on the VR apparatus 20.

The aerial vehicle 30 may be equipped with a cloud platform, and is connected to a camera module through the cloud platform. The camera module may include at least one camera device. The at least one camera device may be configured to collect an image, and further process and store the image, which is not limited herein. The aerial vehicle 30 may control at least two camera devices in the camera module to shoot a panoramic video or a panoramic image, or control any camera device in the camera module to shoot a video or an image within a viewing angle range of the aerial vehicle. The aerial vehicle may acquire the video or image shot by the camera module and transmit the acquired video or image to the VR apparatus 20 via the remote control 10, and the video or image is displayed by the display device in the VR apparatus. In a case that the display device is a mobile phone or a tablet computer, the aerial vehicle 30 may use a device such as a camera module or an image processor to process the acquired image or video, such as splicing and rendering processing, and then transmits the processed image or video to the VR apparatus, thereby reducing a processing load of the display device in the VR apparatus. In the above case, the mobile phone or the tablet computer may also directly establish a communication connection to the remote control, which is not limited herein.

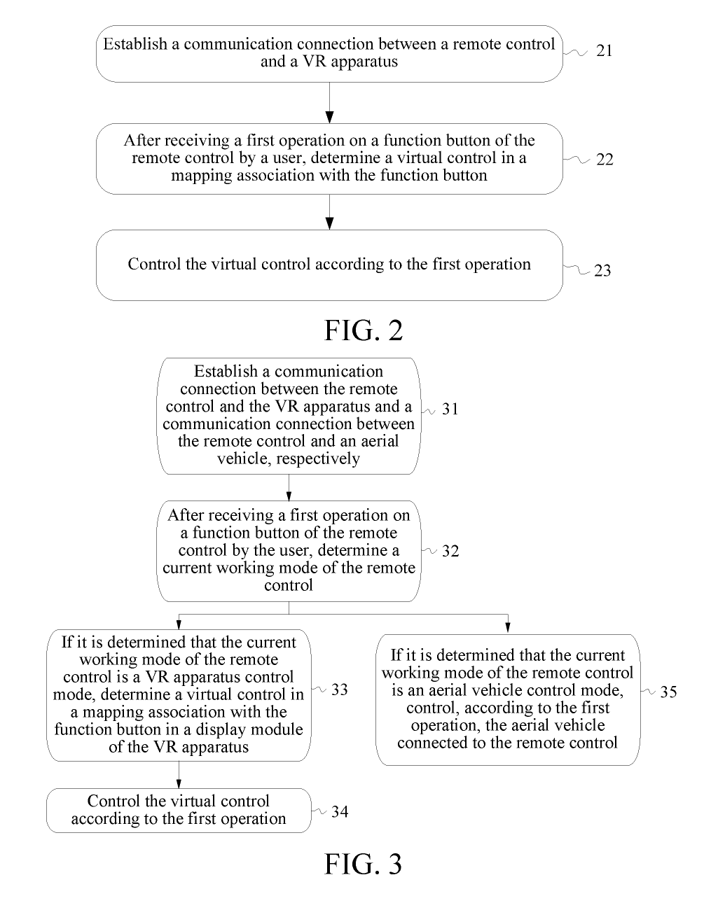

As shown in FIG. 2, a control method for a VR apparatus is provided in an embodiment of the present invention. The method includes: step 21, step 22, and step 23.

Step 21 includes: a communication connection between a remote control and the VR apparatus is established.

In the embodiment of the present invention, the remote control may establish a communication connection to the VR apparatus in a wired or wireless manner. For example, the wireless manner may be performing a wireless communication connection based on a communication technology such as a Wireless-Fidelity (WIFI) technology or Bluetooth, and the wired manner may be performing a wired communication connection using a pluggable USB cable.

Step 22 includes: after a first operation on a function button of the remote control by the user is received, a virtual control in a mapping association with the function button is determined, the virtual control being located on a display interface of the VR apparatus.

In the embodiment of the present invention, the mapping association between the configured function button and the virtual control on the display interface of the VR apparatus may be prestored in the remote control. The display interface of the VR apparatus may be displayed by a display device in the VR apparatus. At least one virtual control may be included on the display interface, the virtual control being configured to process an image displayed on the display interface, or being configured to display a menu, or the like, which is not limited herein.

The mapping association between the function button and the virtual control may be pre-configured or determined by the user, which is not limited herein.

In an implementation, when the remote control is configured with a wheel button, a mapping association between the function button included in the wheel button and the virtual control may be established. The function button may be in a one-to-one mapping relationship with the virtual control, or a one-to-many or many-to-one mapping relationship between the function button and the virtual control may be determined according to quantities of the function buttons and the virtual controls, which is not limited herein.

For example, if the wheel button includes a clockwise rotation button, an anti-clockwise rotation button, and a control button, each of the foregoing function buttons may be in a mapping association with a virtual control respectively. For example, the clockwise rotation button may be in a mapping association with a first virtual control, and the first virtual control may implement a function of controlling a cursor or an image, etc. on the display interface to move upward or controlling the display interface to be switched from a current display menu to a previous display menu. The anti-clockwise rotation button may be in a mapping association with a second virtual control, and the second virtual control may implement a function of controlling a cursor or an image, etc. on the display interface to move downward or controlling the display interface to be switched from a current display menu to a next display menu. The control button may be in a mapping association with a third virtual control, and the third virtual control may implement an acknowledgement function.

Alternatively, both the clockwise rotation button and the anti-clockwise rotation button are in mapping relationships with the first virtual control, or both the clockwise rotation button and the anti-clockwise rotation button are in mapping associations with the second virtual control, which is not limited herein.

Further, when the remote control is configured with a plurality of wheel buttons, with a remote control configured with a first wheel button and a second wheel button as an example, function buttons included in each wheel button may be in a mapping association with one or more virtual controls respectively, or a plurality of function buttons are in mapping relationships with one vertical control, which is not limited herein.

For example, reference may be made to the foregoing description for the mapping association between each function button in the first wheel button and the virtual control. The second wheel button may also include a clockwise rotation button, an anti-clockwise rotation button, and a control button, etc. The clockwise rotation button of the second wheel button may be in a mapping association with a fourth virtual control, the fourth virtual control may implement a function of controlling a cursor or an image on the display interface to move rightward or controlling the display interface to display a sub-menu of a current display menu. The anti-clockwise rotation button of the second wheel button may be in a mapping association with a fifth virtual control, and the fifth virtual control may implement a function of controlling a cursor or an image on the display interface to move leftward or controlling the display interface to display a root menu of a current display menu.

Alternatively, both the clockwise rotation button and the anti-clockwise rotation button of the second wheel button are in mapping relationships with the fourth virtual control, or both the clockwise rotation button and the anti-clockwise rotation button are in mapping relationships with the fifth virtual control, which is not limited herein.

Further, both the control button of the first wheel button and the control button of the second wheel button may be in mapping associations with the third virtual control. In this case, the user may control the third virtual control by operating any one of the control button of the first wheel button or the control button of the second wheel button. Alternatively, the user needs to operate the control button of the first wheel button and the control button of the second wheel button simultaneously to control the third virtual control, which is not limited herein.

In an implementation, when the function button of the remote control is a touchpad, a one-to-one mapping association between upward sliding and an upward function of the virtual control, and between downward sliding and a downward function of the virtual control may be established on the touchpad respectively, a one-to-one mapping association between leftward sliding and a leftward function of the virtual control, and between rightward sliding and a rightward function of the virtual control may be established on the touchpad respectively, and a mapping association between a pressing operation on the touchpad and a determining function of the virtual control may be established.

Step 23 includes: the virtual control is controlled according to the first operation.

In the embodiment of the present invention, the virtual control may be controlled respectively according to an operation duration, an operation track, an operation direction, an operation pressure of the first operation, and the like.

For example, in the above description, if it is detected that the user performs the first operation on the clockwise rotation button of the first wheel button, it may be determined that the virtual control in a mapping association with the clockwise rotation button is the first virtual control. If the first virtual control is configured to implement a function of moving the cursor upward on the display interface, control time of the first virtual control is determined according to the operation duration of the first operation, and a step size or a distance that the cursor moves upward is determined according to the control time, which is not limited herein.

Definitely, functions implemented by the foregoing virtual controls are only illustrative, and the virtual controls may also implement other functions, such as playing back and previewing an image displayed on the display interface, etc. Alternatively, related parameters are set for an image currently displayed on the display interface, which is not limited herein. The virtual control on the display interface may include at least one of a window control, a text box control, a button control, a menu control, or the like, which is not limited herein.

In the embodiment of this application, the remote control may establish a communication connection to the VR apparatus, and may determine the virtual control in a mapping association with the function button after receiving the first operation of the function button configured for the remote control by the user, the virtual control being located on the display interface of the VR apparatus. The determined virtual control may be operated according to the first operation. Through the foregoing method, the user may control display of the VR apparatus by operating the remote control, thereby simplifying user operations and improving user experience.

Referring to FIG. 3, FIG. 3 is a schematic flowchart of a control method for another VR apparatus according to an embodiment of this application. As shown in FIG. 3, the method may include at least the following steps.

In step 31, a communication connection between a remote control and a VR apparatus and a communication connection between the remote control and an aerial vehicle are established respectively.

Reference may be made to corresponding description in the foregoing embodiment for the implementation of the communication connection between the remote control and the VR apparatus, and details are not described herein.

The communication connection between the remote control and the aerial vehicle may be implemented via a wireless network or a wireless technology, which is not limited herein.

The remote control may establish connections to the VR apparatus and the aerial vehicle simultaneously, or establish a connection to the VR apparatus or the aerial vehicle respectively based on other trigger conditions, which is not limited herein.

In step 32, after a first operation on the function button on the remote control by a user is received, a current working mode of the remote control is determined.

In an embodiment, the current working mode of the remote control may include any one of a VR apparatus control mode or an aerial vehicle control mode.

In an implementation, different working modes correspond to different user operations. In this case, the current working mode of the remote control may be determined according to a respective working mode of the first operation. For example, if the first operation of the user can be only used to operate the VR apparatus, a respective working mode of the first operation is the VR apparatus control mode. Alternatively, if the first operation of the user can be only used to operate the aerial vehicle, a respective working mode of the first operation is the aerial vehicle control mode, or the like, which is not limited herein.

Alternatively, the current working mode of the remote control is preset or is switched according to a switching instruction, which is not limited herein.

In step 33, if it is determined that the current working mode of the remote control is the

VR apparatus control mode, a virtual control in a mapping association with the function button in a display module of the VR apparatus is determined.

In step 34, the virtual control is controlled according to the first operation.

In an embodiment, if it is determined that the current working mode of the remote control is the VR apparatus control mode, the control method for the VR apparatus may be performed through step 33 and step 34. Reference may be made to the related description in the foregoing embodiment for the implementations of step 33 and step 34, and details are not described herein.

In step 35, if it is determined that the current working mode of the remote control is the aerial vehicle control mode, the aerial vehicle connected to the remote control is controlled according to the first operation.

In an embodiment, the function button of the remote control may be used to control both the aerial vehicle and a display module in the VR apparatus after switching the working mode. The aerial vehicle may be controlled by controlling a flight direction and/or a flight speed of the aerial vehicle. For example, the wheel button is controlled for forward rotation to control the aerial vehicle for acceleration, and the wheel button is controlled for reverse rotation to control the aerial vehicle for deceleration. It should be noted that a manner of using the function buttons of the remote control to control the flight direction or the flight speed of the aerial vehicle may be preset according to requirements of an actual application, which is not limited in the embodiment of the present invention.

Optionally, a determined current working mode of the remote control may be prompted to the user, an instruction of switching the current working mode by the user may be received, and the current working mode may be switched according to the switching instruction. For example, the switching instruction of the user may be received through a switching button configured on the remote control.

In particular, description will be made in combination with FIG. 1. The remote control 10 may be equipped with a button 12 to generate a respective switching instruction by pressing the button 12, the switching instruction being used to select whether to control the virtual control of the display module in the VR apparatus or to control the aerial vehicle. It should be noted that a manner of controlling the remote control to generate the switching instruction is not limited to generating the switching instruction by pressing the button 12. For example, when a gyroscope is disposed inside the remote control, the remote control may be shaken to trigger the gyroscope to generate the switching instruction. For another example, the switching instruction may also be delivered by the VR apparatus to the remote control.

According to the control method for the VR apparatus provided in an embodiment of the present invention, the mapping association between the function button of the remote control and the virtual control of the display module in the VR apparatus is determined by establishing communication connections between the remote control and the VR apparatus and the aerial vehicle, and the virtual control of the display module in the VR apparatus is controlled according to the mapping association, so that when the user wears the VR apparatus, the remote control is used to select whether to control the virtual control of the display module in the VR apparatus or to control the aerial vehicle, thereby improving user experience.

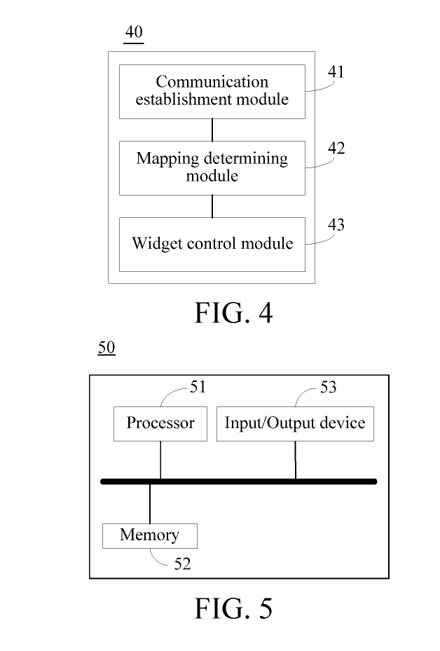

As shown in FIG. 4, a control device 40 for a VR apparatus is provided in an embodiment of the present invention. The control device 40 includes: a communication establishment module 41, a mapping determining module 42, and a widget control module 43.

The communication establishment module 41 is configured to establish a communication connection between a remote control and the VR apparatus.

The mapping determining module 42 is configured to determine a virtual control in a mapping association with a function button after receiving a first operation on the function button of the remote control by the user, the virtual control being located on a display interface of the VR apparatus.

The widget control module 43 is configured to control the virtual control according to the first operation.

Reference may be made to the related description in the foregoing method embodiments for the functions implemented by the foregoing functional module, and details are not described herein.

Definitely, the control device 40 may further include other functional modules, the other functional modules being configured to implement any one of the methods described in the foregoing method embodiments.

The functional module of the control device 40 may be implemented by the following hardware structure or by software or a combination of hardware and software, which is not limited herein.

FIG. 5 is a schematic structural diagram of hardware of a remote control 50 performing a control method for a VR apparatus provided in an embodiment of the present invention. As shown in FIG. 5, the remote control 50 may include:

one or more processors 51, one or more memories 52, and an input/output device 53.

The processor 51, the memory 52, and the input/output device 53 may be connected by a bus or in other manners, and a connection by a bus is used as an example in FIG. 5.

The input/output device 53 separately includes an independent input device and an independent output device, or the input/output device 53 may be an integrated input/output device such as a touch display. If the input/output device 53 includes an independent input device and an independent output device, the input device may include a function button, such as a wheel button and a switching button, and the output device may include a communication device, and the like, which is not limited herein.

As a non-volatile computer readable storage medium, the memory 52 may be configured to store a non-volatile software program, a non-volatile computer-executable program, and a module, such as the respective program instructions/modules of the control method for the VR apparatus in the embodiment of the present invention. For example, if the foregoing functional module is implemented by software, the memory 52 may be configured to store the communication establishment module 41, the mapping determining module 42, and the widget control module 43 shown in FIG. 4. The processor 51 executes various functional applications and data processing of the remote control 50 by running the non-volatile software program, instruction, or module stored in the memory 52, that is, the control method for the VR apparatus in the foregoing method embodiment is implemented.

The memory 52 may include a program storage area and a data storage area. The program storage area may store an operating system and an application required by at least one function, and the data storage area may store data that is created according to use of an electronic device, and the like. In addition, the memory 52 may include a high speed random access memory, and may further include a non-volatile memory, such as at least one magnetic disk storage device, a flash memory device, or other non-volatile solid state storage devices. Optionally, in some embodiments, the memory 52 may include remote memories that are disposed relative to the processor 51, and these remote memories may be connected to the remote control 50 via a network. An example of the foregoing network includes but is not limited to the Internet, an intranet, a local area network, a mobile communication network, and a combination thereof.

One or more modules are stored in the memory 52, and when the one or more modules are executed by the one or more processors 51, the control method for the VR apparatus in any of the foregoing method embodiments is performed. For example, step 21, step 22, and step 23 of the method described above in FIG. 2 are performed.

The foregoing device may perform the control method for the VR apparatus provided in an embodiment of the present invention, and has corresponding functional modules and beneficial effects for performing the method. Reference may be made to the control method for the VR apparatus provided in the embodiment of the present invention for technical details that are not described in detail in this embodiment.

A non-volatile computer readable storage medium is provided in the embodiments of the present invention, and the computer readable storage medium stores a computer-executable instruction, the computer-executable instruction being executed by one or more processors, such as the processor 51 in FIG. 5, so that the foregoing one or more processors perform the control method for the VR apparatus in any of the foregoing method embodiments. For example, step 21, step 22, and step 23 of the method described above in FIG. 2 are performed, or functions of the communication establishment module 31, the mapping determining module 32, and the widget control module 33 shown in FIG. 3 are implemented.

The apparatus embodiments described above are merely schematic. The units described as separate parts may be or may not be physically apart. The parts displayed as units may be or may not be physical units, in other words, may be located at a same place, or may be distributed onto a plurality of network units. Some or all modules thereof may be selected based on an actual requirement, to implement an objective of the solution in this embodiment.

Through the descriptions of the preceding embodiments, a person of ordinary skill in the art may understand that the implementation manners may be implemented by using hardware only or by using software and a universal hardware platform. A person of ordinary skill in the art may understand that all or some of the processes of the methods in the embodiments may be implemented by a computer program instructing relevant hardware. The program may be stored in a computer readable storage medium. When the program is executed, the procedures of the methods in the embodiments are performed. The foregoing storage medium may be a magnetic disk, an optical disc, a read-only memory (ROM), or a random access memory (RAM).

The descriptions are only specific implementations of the present disclosure, but are not intended to limit the protection scope of the present disclosure. Any variation or replacement readily figured out by persons skilled in the art within the technical scope disclosed in the present disclosure shall fall within the protection scope of the present disclosure. Therefore, the protection scope of the present disclosure shall be subject to the protection scope of the claims.

What is claimed is:

1. A control method for a VR apparatus, wherein the method comprises:
establishing a communication connection between a remote control and the VR apparatus;
after receiving a first operation on a function button of the remote control by a user, determining a virtual control in a mapping association with the function button, the virtual control being located on a display interface of the VR apparatus; and
controlling the virtual control according to the first operation.

2. The method according to claim 1, wherein after receiving the first operation on the function button of the remote control by the user, the method further comprises:
determining a current working mode of the remote control; and
the determining the virtual control in the mapping association with the function button comprises:
when it is determined that the current working mode of the remote control is a VR apparatus control mode, determining a virtual control in a mapping association with the function button in a display module of the VR apparatus.

3. The method according to claim 2, wherein the method further comprises:
when it is determined that the current working mode of the remote control is an aerial vehicle control mode, controlling, according to the first operation, the aerial vehicle connected to the remote control.

4. The method according to claim 2, wherein the method further comprises:
receiving a switching instruction; and
switching the current working mode of the remote control according to the switching instruction.

5. The method according to claim 3, wherein the method further comprises:
receiving a switching instruction; and
switching the current working mode of the remote control according to the switching instruction.

6. The method according to claim 1, wherein the method further comprises:
receiving a second operation on the function button of the remote control by the user, the second operation being different from the first operation; and
controlling, according to the second operation, the aerial vehicle connected to the remote control.

7. The method according to claim 1, wherein the virtual control comprises at least one of the following:
a window control, a text box control, a button control, and a menu control.

8. A remote control, comprising:
at least one processor; and
a memory coupled to the at least one processor,
wherein the memory stores a computer instruction and the processor is configured to:
establish a communication connection between the remote control and a VR apparatus;
after receiving a first operation on a function button of the remote control by a user, determine a virtual control in a mapping association with the function button, the virtual control being located on a display interface of the VR apparatus; and
control the virtual control according to the first operation.

9. The remote control according to claim 8, wherein the processor is further configured to:
determine a current working mode of the remote control;
when it is determined that the current working mode of the remote control is a VR apparatus control mode, determine the virtual control in the mapping association with the function button in a display module of the VR apparatus.

10. The remote control according to claim 9, wherein the processor is further configured to:
control, according to the first operation, an aerial vehicle connected to the remote control if it is determined that the current working mode of the remote control is an aerial vehicle control mode.

11. The remote control according to claim 9, wherein the processor is further configured to:
receive a switching instruction; and
switch the current working mode of the remote control according to the switching instruction.

12. The remote control according to claim 10, wherein the processor is further configured to:
receive a switching instruction; and
switch the current working mode of the remote control according to the switching instruction.

13. The remote control according to claim 8, wherein the processor is further configured to:
receive a second operation on the function button of the remote control by the user, the second operation being different from the first operation; and
control, according to the second operation, the aerial vehicle connected to the remote control.

14. The remote control according to claim 8, wherein the virtual control comprises at least one of the following:
a window control, a text box control, a button control, and a menu control.
